(19) United States
(12) Patent Application Publication
(10) Pub. No.: US 2003/0005080 A1
(43) Pub. Date: Jan. 2, 2003

(54) Systems and methods for accessing data

(76) Inventors: James S. Watkins, Richmond, VA (US); Jeffrey P. Hall, Bumpass, VA (US)

Correspondence Address: FINNEGAN, HENDERSON, FARABOW, GARRETT &, DUNNER LLP, 1300 I STREET, NW, WASHINGTON, DC, 20006, US

(21) Appl. No.: 09/892,880

(22) Filed: Jun. 28, 2001

(51) Int. Cl. G06F 15/16

(52) U.S. Cl. 709/218; 709/219

(57) ABSTRACT

A data management system consistent with the present invention communicates with a client terminal. The system includes a virtual address connection defining a network address to which the client terminal sends a request reflecting a function to be performed. The system also includes a plurality of server devices, each capable of performing the server function requested by the client terminal. Each of the plurality of server devices has access to a common storage device. A load balancer, associated with the virtual address connection, receives the request and selects one of the plurality of server devices to perform the requested function. The load balancer routes the request to the selected server device to perform the requested function, and the selected server device accesses the common storage device to perform the request.

### BACKGROUND OF THE INVENTION

1. Field of the Invention

The present invention relates to systems and methods for accessing data and, more particularly, to systems and methods for accessing a data stored in a single storage device using a selected one of a plurality of servers.

2. Description of the Related Art

Computers have become so wide spread that they are now commonplace. A computer system's functionality and usefulness can be dramatically enhanced by coupling stand-alone computers together to form a computer network. In a computer network, users may readily exchange files, share information stored on a common storage device, pool resources, communicate via e-mail, and even video teleconference.

One popular type of network is a “client-server” network. In such a network, a client application program communicates with a server, which is typically a remote computer system accessible over a network. The server, based upon requests from the client process, presents information as server responses to the requests of the client process. The client process may be active in a first computer system, and the server process may be active in a second computer system, and communicate with one another over a communication medium, thus providing distributed functionality and allowing the multiple clients to take advantage of the information gathering capabilities of the server.

Although client-server networks offer a great deal of flexibility and versatility, various core services. For example, users of the client typically store data files on the server storage device, rather than on the hard drive of the computer system running the client process. If the server fails, these files become inaccessible. Such server failures are not uncommon. Further aggravating the problem is the fact that failure is more likely to occur as computers take on more comprehensive and demanding tasks, and that their hardware and software is often more complex to accommodate the increased load.

To make computer systems more reliable, layers of redundancy may be added. When one part of the computer system fails, the failure is detected and a backup device automatically takes over. In some cases, the same work may be performed in parallel by two separate devices in case one of them fails. Of course, these specialized redundant systems come at an extremely high price. Furthermore, upgrading or modifying these types of systems tends to be difficult and expensive. In particular, a substantial amount of hardware and/or software of the computer system usually needs to be modified when making an upgrade, requiring a substantial amount of time and expense.

Another way to add reliability to a client-server system involves shifting the work from a malfunctioning server to one that is in good operating condition. This is accomplished by establishing a new connection to the operational server upon detection of the failure. Work would then continue on the newly connected server. However, this scheme has several disadvantages. Namely, the user of the client process must log-on to the new server and then re-access any data files from the new server. This switch-over process is time consuming, tedious, and frustrating. Another major drawback is the fact that the user will typically lose any data that was not stored at the time of the failure.

Thus, there is a need for an efficient, user-friendly, and cost effective client-server system that can provide a high degree of reliability.

### SUMMARY OF THE INVENTION

Systems and methods consistent with the present invention enable a client-server system to provide a high degree of reliability when accessing data.

To achieve these and other advantages, a data management system consistent with the present invention communicates with a client terminal. The system includes a virtual address connection defining a network address to which the client terminal sends a request reflecting a function to be performed. The system also includes a plurality of server devices, each capable of performing the server function requested by the client terminal. Each of the plurality of server devices has access to a common storage device. A load balancer, associated with the virtual address connection, receives the request and selects one of the plurality of server devices to perform the requested function. The load balancer routes the request to the selected server device to perform the requested function, and the selected server device accesses the common storage device to perform the request.

In another aspect of the invention, a method for operating a data management system that communicates with a client terminal includes receiving a request for performance of a server function from a client terminal. The server process request is received at a virtual address connection defining a network address to which the client terminal sends the request for performance of the server function. The method selects one of a plurality of server devices to perform the requested function, wherein each of the plurality of server devices is capable of performing the requested server function. Each of the plurality of server devices also has access to a common storage device. The client request is forwarded to the selected server device, which then accesses the storage device to perform the request. Based on the performed request, a server response is then forwarded to the client terminal.

Both the foregoing general description and the following detailed description are exemplary and are intended to provide further explanation of the invention as claimed.

### BRIEF DESCRIPTION OF THE DRAWINGS

The accompanying drawings provide a further understanding of the invention and, together with the detailed description, explain the principles of the invention. In the drawings:

FIG. 1 is a block diagram of a data management system 100 consistent with the present invention; and

FIG. 2 is a flow diagram of a method, consistent with the present invention, for accessing data using system 100.

### DETAILED DESCRIPTION

Systems and methods consistent with the present invention provide a reliable data management system for accessing data. Clients send requests to a single virtual address connection, where the requests are received by a load balancer. The load balancer then selects one of a plurality of server devices according to a predetermined algorithm that balances the total processing load among the server devices. Each server device has complete and full access to a common server storage device, and each server is fully capable of handling each request received from a client terminal. The selected server accesses the server storage device for responding to the particular request. In this way, a plurality of redundant server devices are provided that seamlessly respond to requests from the client terminals requesting access to a common server storage device.

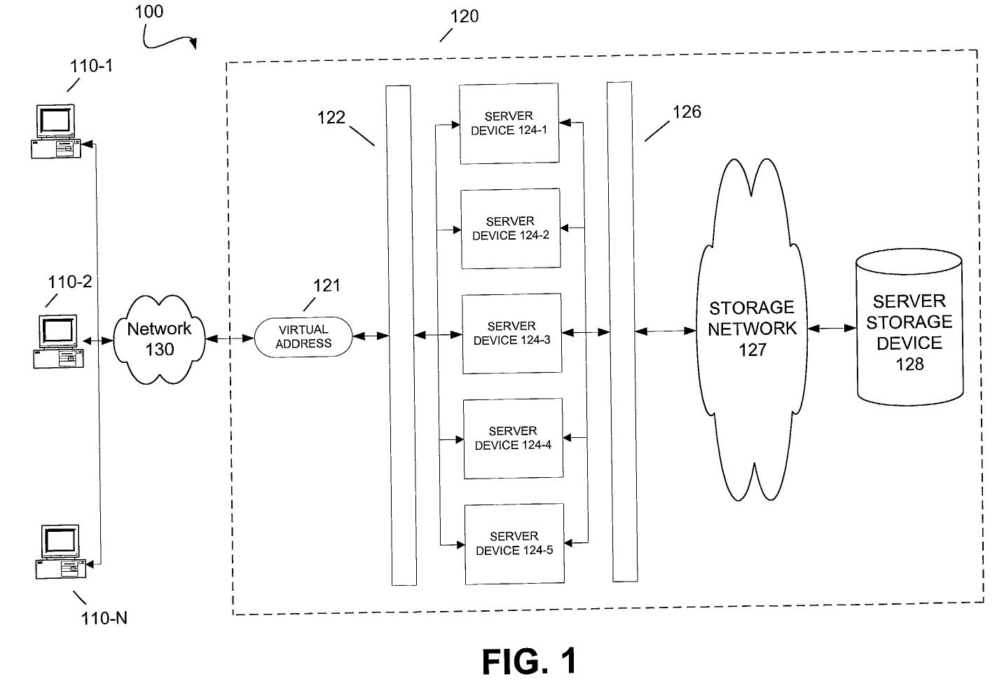

Embodiments of the present invention will now be described with reference to the accompanying drawings. FIG. 1 shows a block diagram of a data management system 100 consistent with the present invention. As shown in FIG. 1, system 100 includes client terminals 110-1 to 110-N for sending data requests to a server unit 120 over a network 130. Network 130 may be any type of network (public or private, local area network or wide area network), such as an Ethernet, an extranet, or the Internet. While FIG. 1 shows only one server unit 120, any number of server units may be used as part of system 100. Further, although the client terminals 110 and server 120 are shown as operating within two computer systems, it will be appreciated by one skilled in the art that the processes of each may be implemented in a variety of software or hardware devices, either programmed or dedicated.

Client terminals 110 may include a personal computer, such as an IBM-compatible computer, or the like, with a connection to network 130. Terminals 110 may be used to execute application programs (not shown), including programs used to submit requests for data files stored on a server storage device. Further, while the description below refers to the client requests as being data file requests, system 100 may manage any type of client request. The operation of application programs and the manner in which they are used to access servers, e.g., accessible via the Internet, an intranet, an extranet, or some equivalent data network, are known in the art.

As shown in FIG. 1, server unit 120 further includes a virtual address connection 121, a load balancer 122, a bank of server devices 124, a data share unit 126, a storage network 127, and a server storage device 128. Client terminals 110 send data file requests to a virtual address connection 121 which is associated with the bank of server devices 124. In systems consistent with the invention, connection 121 may be a network address corresponding to a virtual address of load balancer 122 connected to server devices 124. Thus, unlike a conventional network address, which is unique to an individual network device, virtual address connection 121 effectively identifies all server devices 124. Virtual address connection 121 may be implemented by the software of load balancer 122, such that load balancer 122 may be the actual device that first receives the data requests. However, virtual address connection 121 may alternatively comprise a separate device having a network address to which client terminals 110 send all data file requests.

Load balancer 122 includes a memory such as a local disk storage (not shown), for storing program code that, when executed, selects one of server devices 124 to respond to the received request. The program code selects a server device in a manner that balances the load of processing requests from client terminals 110 among the various server devices 124. For instance, load balancer 122 may randomly select one of server devices 124 for handling a data request from a client terminal. Alternatively, load balancer 122 may select a server device 124 based on a predetermined rotational order. Either way, load balancer 122 transfers to the selected server 124 a connection to the client terminal 110 originating the data file request. The selected server 124 then processes the data file request using server processes as known in the art.

Server devices 124 are preferably standard file servers known in the art, such as a Unisys™ ES7000 file server or a Compaq Prolian 8500 file server. Servers 124 operate in parallel while handling data file requests from client terminals 110. While FIG. 1 shows five server devices 124 as part of server unit 120, any number of servers 124 may be used. Based on the data file request, server devices 124 access server storage device 128, through data share unit 126 and storage network 127. The request sent by a server device 124 may either request retrieval of a file stored in storage device 128 or request storage of a file in storage device 128. For either type of request, data share unit 126 allows servers 124 to operate in parallel without accessing the same storage location of storage device 128 at the same time. Storage network 127 may be implemented using optical fiber switches. Server storage device 128 preferably comprises a large capacity memory capable of maintaining data files for all of client terminals 110. For example, storage device 128 may comprise a 2.5 Terabyte EMC Symetrics storage device.

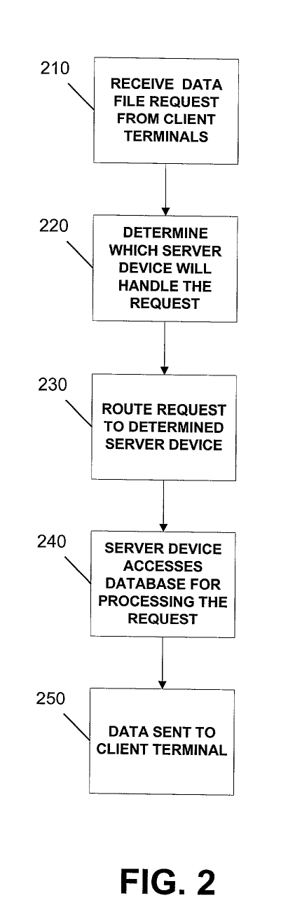

The operation of system 100 will now be described with reference to FIG. 2. FIG. 2 shows a flow diagram of a method consistent with the present invention for handling data file requests using system 100. As shown in FIG. 2, a client using terminal 110 submits a data file request over network 120 to system 100 (step 210). When requesting a data file stored on server storage device 128 (e.g., to manipulate that data file using an application program running on the client terminal), the data request may include the file name, the address storage location of the file, and the network address of the client terminal to which the file should be sent, as well as any other information identifying the file, the user or client terminal requesting the file, or the particular application program requesting the file. When requesting to store a data file on server storage device 128, the data request may include the file name, the network address of the client terminal requesting storage of the file, as well as any other information identifying the file, the user or client terminal requesting storage of the file, or the particular application program requesting storage of the file.

A client terminal 110 sends the data request the virtual network address of virtual address connection 121. Thus, from the standpoint of client terminals 110, each request is sent to a single server located at the virtual address. Each request, however, is actually sent to load balancer 122 for a determination of which of a number of server devices 124 will actually handle the request (step 220). In systems consistent with the present invention, load balancer 122 randomly assigns a particular server device to handle the request. Other methods for balancing the load amongst the bank of server devices 124 may also be used, however, such as cyclically selecting a server device according to a predetermined rotational order. Further, load balancer 122 may determine which server device 124 will handle a request based on the operational status of each server (e.g., the relative load of each server, whether a particular server is currently operational, etc.).

The selected server device is then forwarded the data request (step 230). Based on the type of data request, the server device 124 will then either retrieve a data file from server storage device 128 or store a data file in storage device 128 (step 240). Load balancer 122 allows each server device 124 to see the entire file system structure of server storage device 128. This allows any user to have a data path through any server device 124. Server device 124 performs the file retrieval and storage functions in a manner known to those skilled in the art. Further, in systems consistent with the present invention, server devices 124 may perform only file input-output type functions, and thus may not perform any server based processes, data manipulation, printing functions, or user authorization functions. However, alternative embodiments may use server devices that do perform one or more of these functions or any type of function (e.g., database functions, authorization, and DNS, DHCP, etc.), in addition to or in place of the file input-output functions. For instance, system 100 allows additional server devices to be easily added to the bank of servers 124 to handle any additional load from processing multiple server functions. Further, a separate server systems 100 may be dedicated for handling particular types of requests (e.g., one for handling print functions and another for handling filing functions).

As described above, each server device 124 has complete and full access to server storage device 128. Moreover, in systems consistent with the present invention, a number of servers 124 may operate in parallel such that they may each be handling a data file request from a client terminal at the same time. To prevent two or more servers 124 from accessing the same storage location of storage device 128 at the same time, data share unit 126 monitors the activity of the servers. In particular, when multiple server devices simultaneously try to access the same storage location, data share unit 126 will grant access to only one server device. Preferably, the server devices are granted access in the order that they received the data requests (e.g., the server device that is first to receive a data request is granted access first). Alternatively, server devices 124 may also operate serially such that only one server is handling a request at a given time.

After accessing server storage device 128, the selected server device 124 then forwards a server response to the client terminal 120 that originated the data request (step 250). For example, if the client terminal requested a data file stored on server storage device 128, then server device 124 forwards a server response including the requested file to the client terminal. If, on the other hand, the client terminal requested storage of a data file on storage device 128, then server device 124 forwards a server response including an acknowledgement that the file was stored along with the storage location.

System 100 also allows any specific server device 124 to be seamlessly taken offline for maintenance or trouble. In particular, the processing of client terminals 120 will not be interrupted while an existing server device is taken off line or while a new server device is newly put on line. Moreover, additional server devices may be added to server bank 124 without significantly changing the architecture of system 100. In systems consistent with the present invention, processing of client terminals 110 is not interrupted when adding a new server device to the bank of servers 124. For instance, a network manager may simply update the programming of load balancer 122 to recognize the newly added server. The front end of the system need not be updated as client terminals 110 will still communicate data requests via virtual address connection 121.

Therefore, systems consistent with the present invention provide an efficient, reliable client-server network. Moreover, systems and methods consistent with the invention may be easily updated without requiring a substantial amount of overhaul to other software or hardware network components. It will be apparent to those skilled in the art that various modifications and variations can be made to the system and method of the present invention without departing from the spirit or scope of the invention. For example, system 100 may be dedicated to other types of networking functions other than data retrieval and storage. Additionally, although aspects of the present invention are described as being stored in memory, one skilled in the art will appreciate that these aspects can also be stored on other types of computer-readable media, such as secondary storage devices, like hard disks, floppy disks, or CD-ROM; or other forms of RAM or ROM. The present invention covers the modifications and variations of this invention provided they come within the scope of the appended claims and their equivalents.

What is claimed is:

1. A data management system that communicates with a client terminal, the data server system comprising:
a virtual address connection defining a network address to which the client terminal sends a request reflecting a function to be performed;
a plurality of server devices, each capable of performing the server function requested by the client terminal, and wherein each of the plurality of server devices has access to a common storage device; and
a load balancer, associated with the virtual address connection, for receiving the request and for selecting one of the plurality of server devices to perform the requested function;
wherein the load balancer routes the request to the selected server device to perform the requested function, and wherein the selected server device accesses the common storage device to perform the request.

2. The system of claim 1, wherein the plurality of server devices operate in parallel.

3. The system of claim 1, wherein the request is a data file request and wherein the client terminal sends all requests to the virtual address connection.

4. The system of claim 1, wherein a plurality of client terminals send respective requests to the virtual address connection, and wherein the load balancer determines the one of the plurality of server devices that will perform the server function requested by each of the plurality of client terminals.

5. The system of claim 1, wherein the load balancer randomly determines the server device that will perform the server function.

6. The system of claim 1, wherein the load balancer determines the server device that will perform the server function according to a predetermined rotational order.

7. The system of claim 1, wherein the load balancer determine the server device that will perform the function based on a current processing load of each server device.

8. The system of claim 1, further including:
a data share unit for preventing multiple server devices from simultaneously accessing the same storage location of the server storage device.

9. A method for operating a data management system that communicates with a client terminal, the method comprising:
receiving a request for performance of a server function from a client terminal, wherein the server process request is received at a virtual address connection defining a network address to which the client terminal sends the request for performance of the server function;
selecting one of a plurality of server devices to perform the requested function, wherein each of the plurality of server devices is capable of performing the requested server function, and wherein each of the plurality of server devices has access to a common storage device;
forwarding the client request to the selected server device;
accessing, using the selected server device, the storage device to perform the request; and
forwarding, based on the performed request, a server response to the client terminal.

10. The method of claim 9, wherein the plurality of server devices operate in parallel.

11. The method of claim 9, wherein the request is a data file request, and wherein receiving the server process request includes:
receiving all data file requests from the client terminal at the virtual address connection.

12. The method of claim 9, wherein receiving the server process request includes receiving requests from a plurality of client terminals at the virtual address connection, and wherein determining one of the plurality of server devices further includes determining each of the plurality of server devices that will perform one of the server functions requested by each of the plurality of client terminals.

13. The method of claim 9, wherein determining one of the plurality of server devices further includes:
randomly determining the server device that will perform the server function.

14. The method of claim 9, wherein determining one of the plurality of server devices further includes:
determining the server device that will perform the server function according to a predetermined rotational order.

15. The method of claim 9, wherein determining one of the plurality of server devices further includes:
determining the server device that will perform the server function based on a current processing load of each server device.

16. The method of claim 9, further including:
preventing multiple server devices from simultaneously accessing the same storage location of the server storage device.
